(19) United States
(12) Patent Application Publication
(10) Pub. No.: US 2020/0083632 A1
(43) Pub. Date: Mar. 12, 2020

(54) CONNECTOR

(71) Applicant: IRISO ELECTRONICS CO., LTD., Kanagawa (JP)

(72) Inventor: Ken Chiba, Kanagawa (JP)

(21) Appl. No.: 16/611,164

(22) PCT Filed: Apr. 26, 2018
(86) PCT No.: PCT/JP2018/017104

§ 371 Date: Nov. 5, 2019

(30) Foreign Application Priority Data
May 9, 2017 (JP) 2017-092783

(51) Int. Cl. H01R 13/422; H01R 13/436; H01R 13/533; H01R 12/77

(52) U.S. Cl. CPC H01R 13/4223; H01R 12/774; H01R 13/533; H01R 13/4362

(57) ABSTRACT

A connector includes a terminal configured to electrically connect to an insertable and removable connection target, a housing configured to accommodate the terminal, and a retainer configured to fit into the housing in which the terminal is accommodated. The terminal includes a base end portion provided with an electric cable connection portion (flexible wiring member connection portion) configured to connect to an electric cable (flexible wiring member), a leading end portion provided with a contact portion configured to contact a connection target, and a spring portion positioned between the base end portion and the leading end portion. When the retainer is in a state fitted to the housing, the base end portion is movable with respect to the housing within a predetermined movable region in a connector front-rear direction that is an insertion/removal direction of the connection target.

### CROSS-REFERENCE TO RELATED APPLICATION(S)

This application is a Section 371 National Stage of International Application No. PCT/JP2018/017104, filed on 26 Apr. 2018, which published as WO 2018/207651 A1 on 15 Nov. 2018, which claims priority to Japanese Patent Application No. 2017-092783, filed on May 9, 2017, the contents of which are hereby incorporated by reference in their entireties.

### TECHNICAL FIELD

The present invention relates to a connector.

### BACKGROUND ART

Hitherto, vehicle interior wiring connections have employed connectors such as that disclosed in Patent Document 1.

The connector disclosed in Patent Document 1 includes a housing, a press-contact terminal that is accommodated in the housing and of which one end (terminal) is connected to a connection target and another end (barrel) forms a press-contact connection with an electric cable, and a retainer that is fitted into the housing. Fitting the retainer into the housing prevents the press-contact terminal connected to the electric cable from detaching inside the housing.

This connector exploits the flexibility of the electric cable during an operation to connect the connector and the connection target together such that the connector can be manipulated relatively freely, and is thus easy to work with.

Patent Document 1: Japanese Patent Application Laid-Open (JP-A) No. 2014-186934

### SUMMARY OF INVENTION

### Technical Problem

However, in a connector such as that described above, if the electric cable flexes as a result of vibration or shock in a state connected to the connection target, the press-contact terminal accommodated in the housing might be tugged or pushed in by the electric cable. If this occurs, a contact point with the connection target at the one end (terminal) of the press-contact terminal might slide.

Moreover, in a connector such as that described above, the target for connection to the other end of the terminal may be a flexible printed circuit (FPC: flexible printed circuit board or flexible printed wiring board) or a flexible flat cable (FFC) instead of an electric cable (namely, the connector may be configured as an FPC connector or an FFC connector). FPCs and FFCs have similar flexibility to an electric cable, and are able to flex. In such cases, similarly to in the case of an electric cable, such flexing may be transmitted to the terminal and cause sliding of the contact point.

In consideration of the foregoing circumstances, an object of the present invention is to provide a connector capable of suppressing sliding of a contact point when a flexible wiring member (electric cable, FPC, FFC, or the like) flexes as a result of a vibration or shock.

### Solution to Problem

A connector according to a first aspect includes a terminal configured to electrically connect to an insertable and removable connection target, a housing configured to accommodate the terminal, and a retainer configured to fit into the housing in which the terminal is accommodated. The terminal includes a base end portion provided with a flexible wiring member connection portion configured to connect to a flexible wiring member, a leading end portion provided with a contact portion configured to contact the connection target, and a spring portion positioned between the base end portion and the leading end portion. The leading end portion is prevented from detaching either by the housing, or by the housing and the retainer working in combination, and when the retainer is in a state fitted to the housing, the base end portion is capable of moving with respect to the housing within a predetermined movable region in a connector front-rear direction that is an insertion/removal direction of the connection target.

In the connector according to the first aspect, the connector includes the terminal, the housing, and the retainer. The retainer is fitted into the housing in which the terminal is accommodated. The terminal includes the leading end portion provided with the contact portion configured to contact the connection target. The leading end portion is either prevented from detaching by the housing and the retainer working in combination, or is prevented from detaching by the housing (for example by being press-fitted into the housing).

The base end portion is capable of moving with respect to the housing in the connector front-rear direction, this being the insertion/removal direction of the connection target. The terminal further includes the spring portion positioned between the base end portion and the leading end portion.

Accordingly, even if the flexible wiring member (electric cable, FPC, FFC, or the like) flexes so as to tug or push in the terminal in the connector front-rear direction as a result of vibration, shock, or the like, the base end portion provided with the flexible wiring member connection portion moves in the connector front-rear direction with respect to the housing, thereby enabling the effect of the flexing on the housing to be suppressed. As a result, the flexing can be suppressed from affecting the leading end portion through the housing.

Moreover, even if the flexible wiring member flexes so as to tug or push in the terminal in the connector front-rear direction as a result of vibration, shock, or the like, the spring portion positioned between the leading end portion and the base end portion deforms in response to this flexing, thereby enabling the effect of the flexing on the leading end portion provided with the contact portion to be suppressed.

Sliding of the contact point between the contact portion and the connection target is suppressed by this operation.

Moreover, movement of the base end portion with respect to the housing in the connector front-rear direction is limited to the predetermined movable region. This suppresses plastic deformation of the spring portion.

A connector according to a second aspect is the connector of the first aspect, wherein the housing includes a leading end placement portion at which the leading end portion can be disposed, the leading end placement portion includes a leading end-forward restriction portion configured to limit a movement range of the leading end portion in a connector forward direction that is a removal direction of the connection target, and the retainer includes a leading end-rearward restriction portion configured to, when the retainer is in a state fitted to the housing, limit a movement range of the leading end portion in a connector rearward direction that is an insertion direction of the connection target.

In the connector according to the second aspect, the housing includes the leading end placement portion at which the leading end portion can be disposed. The leading end placement portion includes the leading end-forward restriction portion configured to limit the movement range of the leading end portion in the connector forward direction. The retainer includes the leading end-rearward restriction portion configured to limit the movement range of the leading end portion in the connector rearward direction when the retainer is in a state fitted to the housing.

Accordingly, when accommodating the terminal in the housing, the terminal can be provisionally positioned with respect to the housing by pushing in the terminal until the leading end portion of the terminal abuts the leading end-forward restriction portion of the leading end placement portion. Detachment of the leading end portion of the terminal is then prevented by fitting the retainer into the housing. This enables easy assembly.

A connector according to a third aspect is the connector of the first aspect or the second aspect, wherein the housing includes a bottom portion configured to restrict movement of the base end portion in a fitting direction of the retainer, and an abutting portion configured to restrict a movement range of the base end portion in a fitting-opposite direction that is the opposite direction from the fitting direction of the retainer.

In the connector according to the third aspect, the housing includes the bottom portion configured to restrict movement of the base end portion in the fitting direction of the retainer, and the abutting portion configured to restrict the movement range of the base end portion in the fitting-opposite direction, this being the opposite direction from the fitting direction of the retainer. Accordingly, in a state in which the terminal is accommodated in the housing but the retainer has not yet been fitted into the housing, the base end portion is prevented from moving by a large amount in the fitting direction or the fitting-opposite direction. This enables the connector to be assembled easily.

A connector according to a fourth aspect is the connector of the third aspect, wherein a movement clearance permitting movement of the base end portion in a connector up-down direction that is a fitting direction/fitting-opposite direction of the retainer is present between the base end portion and the bottom portion and between the base end portion and the abutting portion, and the base end portion is movable within a predetermined movement range in the connector up-down direction when the retainer is in a fitted state to the housing.

In the connector according to the fourth aspect, the movement clearance that permits movement of the base end portion in the connector up-down direction is present between the base end portion and the bottom portion and between the base end portion and the abutting portion. In a state in which the retainer has been fitted into the housing, the base end portion is movable within a predetermined movement range in the connector up-down direction.

Accordingly, even if the flexible wiring member flexes so as to move the terminal in the connector up-down direction, the effect of the flexing on the housing and the retainer can be reduced. As a result, the flexing can be suppressed from affecting the leading end portion through the housing and the retainer.

Moreover, even if the flexible wiring member flexes so as to tug or push in the terminal in the connector up-down direction as a result of vibration, shock, or the like, the spring portion positioned between the leading end portion and the base end portion deforms in response to this flexing, thereby enabling the effect of the flexing on the leading end portion provided with the contact portion to be reduced.

Moreover, the movement range of the base end portion in the connector up-down direction is limited to a predetermined range, thereby suppressing plastic deformation of the spring portion.

A connector according to a fifth aspect is the connector of any one of the first aspect to the fourth aspect, wherein the base end portion is accommodated in a state in which a gap between the base end portion and the housing is present in a connector width direction that is a direction perpendicular both to an insertion direction of the connection target and to a fitting direction of the retainer, and the base end portion is movable in the connector width direction over a range of the gap when the retainer is in a fitted state to the housing.

In the connector according to the fifth aspect, the base end portion is accommodated in a state in which a gap is present between the base end portion and the housing in the connector width direction, this being a direction perpendicular to both the insertion direction of the connection target and the fitting direction of the retainer. In the fitted state of the retainer to the housing, the base end portion is movable in the connector width direction over the range of the gap. Namely, in the fitted state of the retainer to the housing, the retainer is movable within a predetermined movement range in a connector left-right direction.

Accordingly, even if the flexible wiring member flexes so as to move the terminal in the connector left-right direction, the effect of the flexing on the housing and the retainer can be reduced. As a result, the flexing can be suppressed from affecting the leading end portion through the housing and the retainer.

Moreover, even if the flexible wiring member flexes so as to tug or push in the terminal in the connector left-right direction as a result of vibration, shock, or the like, the spring portion positioned between the leading end portion and the base end portion deforms in response to this flexing, thereby enabling the effect of the flexing on the leading end portion provided with the contact portion to be reduced.

Moreover, the movement range of the base end portion in the connector left-right direction is limited to a predetermined range, thereby suppressing plastic deformation of the spring portion.

A connector according to a sixth aspect is the connector of any one of the first aspect to the fifth aspect, wherein an insertion-removal axis of the contact portion is substantially parallel to a connection axis of the flexible wiring member connection portion, and is at a position that is offset with respect to the connection axis of the flexible wiring member connection portion in a fitting direction of the retainer.

In the connector according to the sixth aspect, the insertion-removal axis of the contact portion is substantially parallel to the connection axis of the flexible wiring member connection portion, and is at a position that is offset with respect to the connection axis of the flexible wiring member connection portion in the fitting direction of the retainer. Accordingly, the ease of deformation of the spring portion can be secured while suppressing an increase in a front-rear direction dimension of the connector, while still effectively suppressing sliding of the contact point.

A connector according to a seventh aspect is the connector of the sixth aspect, wherein the spring portion includes a doubling-back portion that doubles back in a connector rearward direction that is an insertion direction of the connection target.

In the connector according to the seventh aspect, not only are the insertion-removal axis and the connection axis of the flexible wiring member connection portion disposed at positions offset with respect to each other in the connector up-down direction, the spring portion extending from the base end portion to the leading end portion includes the doubling-back portion that doubles back in the connector rearward direction. This enables even easier deformation of the spring portion to be secured, while even more effectively suppressing sliding of the contact point.

### Advantageous Effects of Invention

As described above, the present invention exhibits the excellent advantageous effect of being able to suppress sliding of a contact point even if an electric cable flexes as a result of vibration or shock.

### BRIEF DESCRIPTION OF DRAWINGS

FIG. 1 is an exploded perspective view illustrating a connector of a first exemplary embodiment.

FIG. 2 is a perspective view illustrating a connector in an assembled state.

FIG. 3 is a side view cross-section illustrating a connector in an assembled state, as viewed along a direction from the left of the connector.

FIG. 4 is a perspective view illustrating a terminal.

FIG. 5 is a side view illustrating a terminal as viewed along a direction from the left of the terminal.

FIG. 6 is a cross-sectional perspective view illustrating a state in which a terminal is accommodated in a housing.

FIG. 7 is a cross-sectional perspective view illustrating a retainer.

FIG. 8 is an enlarged side view cross-section illustrating the vicinity of a base end side restricted portion in an assembled state.

FIG. 9 is a side view cross-section corresponding to FIG. 8, illustrating a state in which an electric cable has been tugged when in an assembled state.

FIG. 10 is a side view cross-section corresponding to FIG. 8, illustrating a state in which an electric cable has been pushed in when in an assembled state.

FIG. 11 is an enlarged cross-section (a cross-section sectioned along a plane orthogonal to a connector front-rear direction) illustrating the vicinity of a base end side restricted portion in an assembled state.

FIG. 12 is an exploded perspective view illustrating a connector of another exemplary embodiment.

FIG. 13 is a perspective view illustrating a state following on from the state in FIG. 12, in which plural terminals are accommodated in a housing.

FIG. 14 is a perspective view illustrating a state following on from the state in FIG. 13, in which a retainer has been fitted.

FIG. 15 is a perspective view illustrating a state following on from the state in FIG. 14, in which a cover has been attached, namely an assembled state of a connector.

FIG. 16 is a perspective view illustrating a state in which an FPC has been plugged into a connector in an assembled state.

FIG. 17 is a cross-sectional perspective view corresponding to the state illustrated in FIG. 16.

FIG. 18 is a cross-section corresponding to FIG. 17 as viewed from a side of a connector.

FIG. 19 is a cross-section in which a terminal illustrated in FIG. 18 is omitted from illustration.

FIG. 20 is a perspective view illustrating a terminal of another exemplary embodiment.

FIG. 21 is a side view illustrating a terminal of another exemplary embodiment.

### DESCRIPTION OF EMBODIMENTS

Explanation follows regarding a connector 10 according to an exemplary embodiment of the present invention.

### Connector

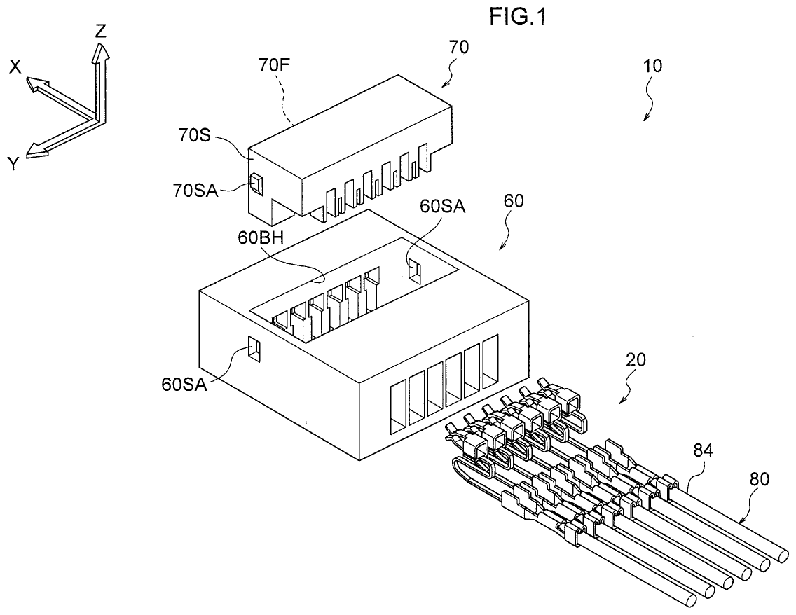

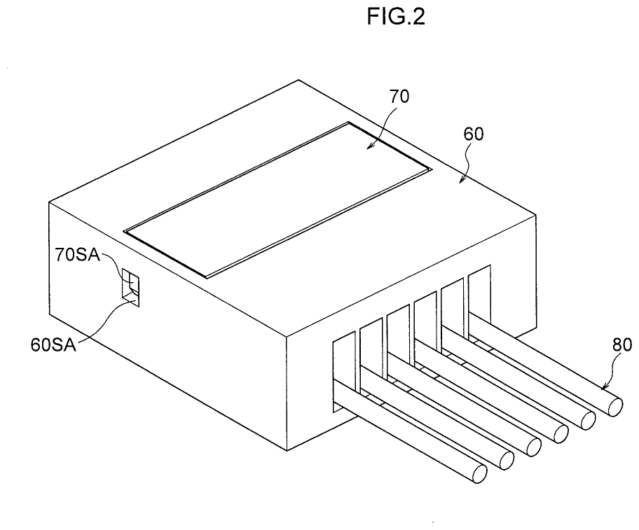

As illustrated in FIG. 1, the connector 10 of the present exemplary embodiment includes plural (six) terminals 20, a housing 60, and a retainer 70. The connector 10 is assembled by first accommodating the terminals 20 in the housing 60, and then fitting the retainer 70 into the housing 60 in which the terminals 20 are accommodated (see FIG. 2).

### Terminals

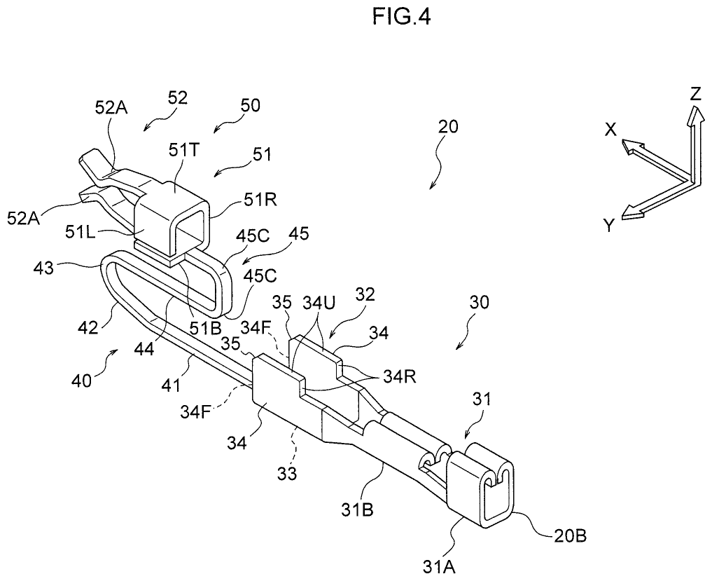

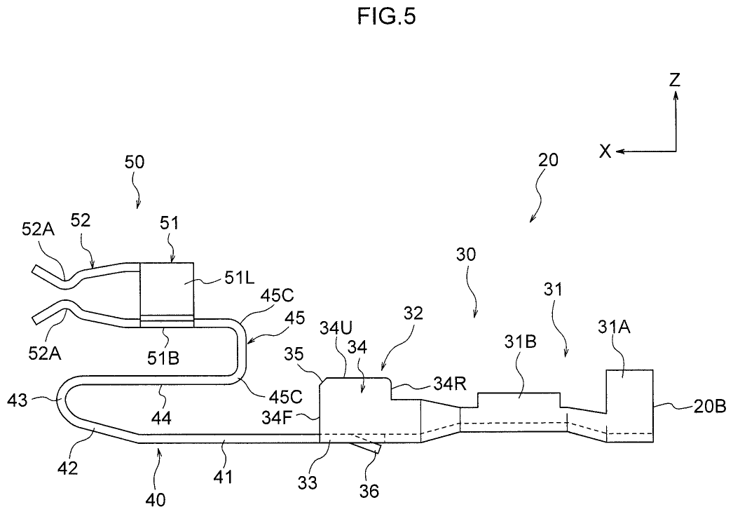

The six terminals 20 are configured similarly to each other. One of the six terminals 20 is illustrated in FIG. 4 and FIG. 5. Explanation follows regarding this terminal 20 with reference to FIG. 4 and FIG. 5.

In the following explanation regarding the terminal 20, the arrow X, the arrow Y, and the arrow Z illustrated in FIG. 4 and FIG. 5 respectively indicate a terminal forward direction, one side (a left direction) in a terminal width direction, and a terminal upward direction. Unless specifically stated otherwise, reference to the front and rear, up and down, and width (left and right) is understood to refer to the front and rear in a terminal front-rear direction, upward and downward in a terminal up-down direction, and width (left and right) in the terminal width direction (left-right direction). In an assembled state of the connector 10, the front, rear, left, right, upward, and downward directions of the six terminals 20 are substantially aligned with the front, rear, left, right, upward, and downward directions of the connector 10.

The terminals 20 are, for example, formed by punching and then bending a sheet material. The material employed for the terminals 20 is a material with electrically conductive properties, such as a copper alloy.

The terminal 20 includes a base end portion 30 configuring one end side of the terminal 20, a leading end portion 50 configuring the other end side of the terminal 20, and a spring portion 40 positioned between the leading end portion 50 and the base end portion 30.

### Base End Portion 30

The entire base end portion 30 is bent upward (toward a plate thickness direction inner face side) at both width direction sides. A cross-section profile of the base end portion 30 as sectioned orthogonally to the front-rear direction has an upward-opening U-shape or C-shape. The base end portion 30 extends toward the front from a rear end 20B of the terminal 20. The base end portion 30 includes an electric cable connection portion 31 and a base end side restricted portion 32 in this sequence on progression from the one end side toward the other end side.

### Electric Cable Connection Portion 31

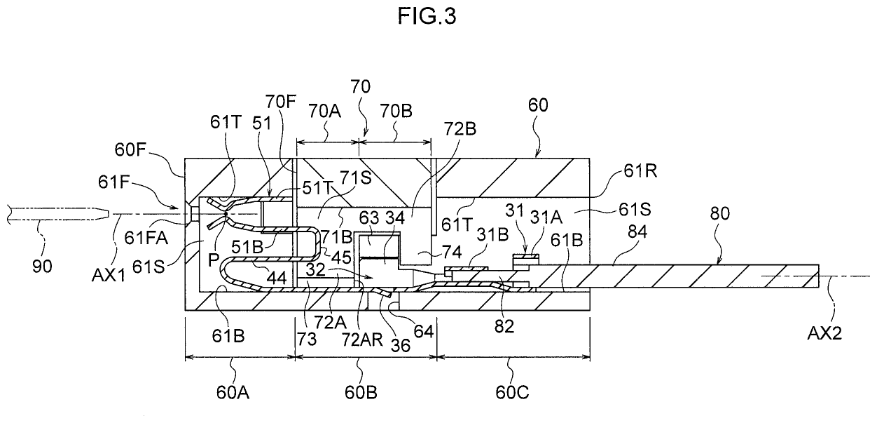

The electric cable connection portion 31 is a portion for connection to an electric cable 80 serving as a flexible wiring member, and corresponds to a flexible wiring member connection portion of the present invention. The electric cable connection portion 31 includes a sleeve press portion 31A that is pressed against a sleeve 84 of the electric cable 80 (see FIG. 1), and a core press portion 31B that is pressed against a core 82 (see FIG. 3) of the electric cable 80.

### Base End Side Restricted Portion 32

The base end side restricted portion 32 is a portion configured to abut the housing 60 and the retainer 70 in order to limit a movement range of the base end portion 30. The base end side restricted portion 32 has an upward-opening U-shaped cross-section profile as sectioned orthogonally to the terminal front-rear direction. Namely, the base end side restricted portion 32 includes a bottom plate portion 33 extending in the width direction, a right side plate portion 34 extending upward from a right side end portion of the bottom plate portion 33, and a left side plate portion 34 extending upward from a left side end portion of the bottom plate portion 33. The right side plate portion 34 and the left side plate portion 34 of the base end side restricted portion 32 are also collectively referred to as the pair of side plate portions 34 of the base end side restricted portion 32.

Each of the side plate portions 34 includes a front-facing front face 34F, an upward-facing upper face 34U, and a rear-facing rear face 34R. Tapered faces 35 facing in an oblique direction running upward and toward the front are formed between the front faces 34F and the upper faces 34U.

As illustrated in FIG. 5, the bottom plate portion 33 of the base end side restricted portion 32 is formed with a lance 36. The lance 36 is formed by bending a width direction central portion of the bottom plate portion 33 downward (toward a plate thickness direction outer face side).

### Spring Portion 40

The spring portion 40 includes a first linear portion 41, an inclined portion 42, a first bent portion 43, a second linear portion 44, and a second bent portion 45 in this sequence on progression from the one end side toward the other end side. The spring portion 40 has a substantially uniform width dimension from one end to the other end. This width dimension is smaller than a width dimension of the base end side restricted portion 32, and is more specifically a dimension of no greater than one third of the width dimension of the base end side restricted portion 32.

The first linear portion 41 extends toward the front from a width direction central portion of the bottom plate portion 33 of the base end side restricted portion 32. The plate thickness direction of the first linear portion 41 is oriented in the up-down direction, and the first linear portion 41 extends in a straight line toward the front from the one end toward the other end. The extension direction of the first linear portion 41 is substantially parallel to the terminal front-rear direction. The other end side of the first linear portion 41 is joined to the inclined portion 42 through a kinked portion kinked slightly toward the plate thickness direction inner face side.

The plate thickness direction of the inclined portion 42 is substantially oriented in the up-down direction, and the inclined portion 42 extends in a straight line from one end to the other end in a direction inclined slightly upward with respect to the forward direction (an oblique direction running upward and toward the front). An angle formed between the extension direction of the inclined portion 42 and the terminal front-rear direction is less than 45°, and is set to approximately 20° in the present exemplary embodiment. An extension direction other end side of the inclined portion 42 is joined to the first bent portion 43.

The first bent portion 43 is bent toward the plate thickness direction inner face side, and has a curved profile protruding toward the front. The extension direction of the first bent portion 43 is transformed through approximately 160° between one end and the other end thereof. The extension direction other end side of the first bent portion 43 is joined to the second linear portion 44.

The plate thickness direction of the second linear portion 44 is substantially oriented in the up-down direction, and the second linear portion 44 extends in a straight line toward the rear from one end to the other end. The extension direction of the second linear portion 44 is substantially parallel to the terminal front-rear direction. The extension direction other end side of the second linear portion 44 is joined to the second bent portion 45.

The second bent portion 45 is bent toward the plate thickness direction outer face side, and has a rearward-protruding profile. Specifically, the second bent portion 45 is configured including two kinked portions 45C, each bent by approximately 90°. The extension direction of the second bent portion 45 is transformed through approximately 180° between one end and the other end thereof. The extension direction other end side of the second bent portion 45 is joined to a leading end side restricted portion 51 of the leading end portion 50.

### Leading End Portion 50

The leading end portion 50 includes the leading end side restricted portion 51 and a contact portion 52. The leading end side restricted portion 51 is a portion configured to abut the housing 60 and the retainer 70 in order to limit a movement range of the leading end portion 50. The contact portion 52 is a portion configured to contact a connection target 90.

The leading end side restricted portion 51 has a substantially rectangular shaped cross-section profile as sectioned orthogonally to the front-rear direction. Specifically, the leading end side restricted portion 51 is configured by a lower plate portion 51B, a right plate portion 51R extending upward from a right side end portion of the lower plate portion 51B, an upper plate portion 51T extending toward the left side from an upper end of the right plate portion 51R, and a left plate portion 51L extending downward from a left side end portion of the upper plate portion 51T. A width direction central portion of a rear end of the lower plate portion 51B is joined to the spring portion 40.

The contact portion 52 includes a pair of contact tabs 52A. Each of the pair of contact tabs 52A extends toward the front from a width direction central portion of a front end of either the upper plate portion 51T or the lower plate portion 51B of the leading end side restricted portion 51 of the leading end portion 50. The pair of contact tabs 52A are configured to form an electrical connection with the connection target 90 by forming a contact with the connection target 90 in the up-down direction.

### Housing 60

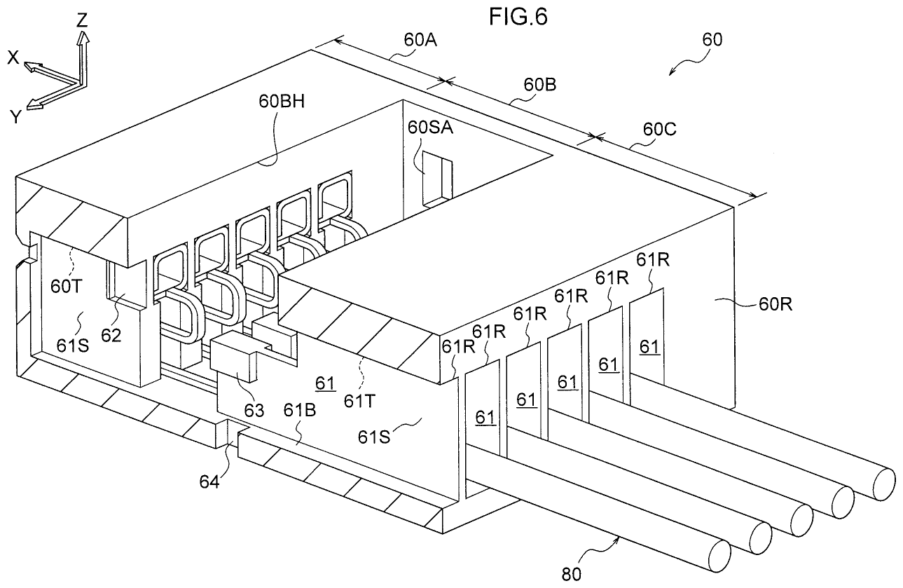

Explanation follows regarding the housing 60, with reference to FIG. 1 and FIG. 6. The housing 60 is formed in a substantially rectangular block shape from an insulating body configured by a synthetic resin or the like.

In the following explanation regarding the housing 60, the arrow X, the arrow Y, and the arrow Z respectively indicate a housing forward direction, one side (a left side) in a housing width direction, and a housing upward direction. Unless specifically stated otherwise, reference to the front and rear, up and down, and width (left and right) is understood to refer to the front and rear in a housing front-rear direction, up and down in a housing up-down direction, and width (left and right) in the housing width (left-right) direction. Note that the front-rear, left-right, and up-down directions of the housing 60 are aligned with the front-rear, left-right, and up-down directions of the connector 10.

### Accommodation Portion 61

The housing 60 includes accommodation portions 61 configured to accommodate the terminals 20. Each of the accommodation portions 61 is formed by a space extending along the front-rear direction within the housing 60. Plural of the accommodation portions 61 are formed (six in the present exemplary embodiment so as to correspond to the number of the terminals 20). The six accommodation portions 61 are configured similarly to each other, and are formed at uniform spacings in the housing width direction.

FIG. 6 is a cross-section sectioned along a plane perpendicular to the housing left-right direction at a width direction central portion of the accommodation portion 61 furthest to the left side out of the six accommodation portions 61. The terminal 20 corresponding to the accommodation portion 61 furthest to the left side is omitted from illustration, whereas the other accommodation portions 61 are illustrated in a state in which the respective terminals 20 are accommodated therein.

A rear face 60R of the housing 60 is formed with terminal push-in openings 61R. The terminal push-in openings 61R are in communication with the corresponding accommodation portions 61. The terminals 20 are pushed into the accommodation portions 61 through the terminal push-in openings 61R in order to accommodate the terminals 20 in the respective accommodation portions 61. Specifically, as illustrated in FIG. 1, the terminals 20 can be accommodated in the accommodation portions 61 by pushing the terminals 20 in toward the front through the terminal push-in openings 61R in the rear face 60R of the housing 60 in a state in which the front-rear and left-right directions of the terminal 20 are aligned with the front-rear and left-right directions of the housing 60, as illustrated in FIG. 1.

As illustrated in FIG. 6, a front-rear direction intermediate portion 60B (housing intermediate portion 60B) of the housing 60 is formed with a substantially rectangular shaped retainer-fitting opening 60BH that opens upward from the housing. The retainer-fitting opening 60BH is in communication with the six accommodation portions 61. A top face 61T of the accommodation portions 61 is therefore not present at the housing intermediate portion 60B.

### Housing Rear Portion, Pair of Left and Right Side Wall Faces

The plural accommodation portions 61 are separated from each other in a rear portion 60C (housing rear portion 60C) of the housing 60. Namely, in the housing rear portion 60C, a pair of left and right side wall faces 61S are formed spanning from a bottom face 61B to a top face 61T for each of the accommodation portions 61.

As illustrated in FIG. 3, the electric cable connection portion 31 of the base end portion 30 of the corresponding terminal 20 and the corresponding electric cable 80 are disposed between each pair of left and right side wall faces 61S in the housing rear portion 60C.

In the housing intermediate portion 60B, the pairs of left and right side wall faces 61S are formed lower than the side wall faces 61S in the housing rear portion 60C. The height of the side wall faces 61S of the housing intermediate portion 60B corresponds to a position lower than the top face 61T of the housing rear portion 60C.

Moreover, the side wall faces 61S in the housing intermediate portion 60B are interrupted at a front-rear direction intermediate position of the housing intermediate portion 60B. Namely, if the housing intermediate portion 60B is further divided into a front side and a rear side, the side wall faces 61S are formed at the rear side of the housing intermediate portion 60B, but the side wall faces 61S are not formed at the front side of the housing intermediate portion 60B.

As illustrated in FIG. 3, the base end side restricted portion 32 of the terminal 20 is disposed between the left and right pair of the side wall faces 61S in the housing intermediate portion 60B (within the accommodation portion 61 in the housing intermediate portion 60B).

The plural accommodation portions 61 are separated from each other in a front portion 60A (housing front portion 60A) of the housing 60. Namely, in the housing front portion 60A, a pair of left and right side wall faces 61S are formed spanning from the bottom face 61B to the top face 61T for each of the accommodation portions 61. The height of the top face 61T at the housing rear portion 60C is the same as the height of the top face 61T at the housing front portion 60A.

As illustrated in FIG. 3, part of the spring portion 40 (for example the first bent portion 43) and the leading end portion 50 of the corresponding terminal 20 are disposed between the left and right pair of the side wall faces 61S in the housing front portion 60A (inside the accommodation portion 61 in the housing front portion 60A).

In the housing rear portion 60C and the housing intermediate portion 60B, a spacing between each left and right pair of the side wall faces 61S (a width dimension of the accommodation portion 61) is formed so as to be larger than the width dimensions of the leading end side restricted portion 51 and the base end side restricted portion 32 of the corresponding terminal 20. Accordingly, when the terminal 20 is pushed into the accommodation portion 61, the leading end side restricted portion 51 and the base end side restricted portion 32 are capable of passing between the pair of left and right side wall faces 61S of the housing rear portion 60C in the front-rear direction. Accordingly, in a state in which the terminal 20 is accommodated in the corresponding accommodation portion 61, the base end side restricted portion 32 is capable of being disposed between the pair of left and right side wall faces 61S in the housing intermediate portion 60B.

Conversely, in the housing front portion 60A, the spacing between each left and right pair of the side wall faces 61S is formed so as to be smaller than the width dimension of the leading end side restricted portion 51.

However, at a portion of the housing front portion 60A that adjoins the housing intermediate portion 60B in the vicinity of the top face 61T, recesses 62 are formed to increase the spacing between each left and right pair of the side wall faces 61S. One of the recesses 62 is formed to each of the left and right pair of side wall faces 61S such that each of the accommodation portions 61 is formed with a left and right pair of the recesses 62.

The spacing between each left and right pair of the recesses 62 is formed so as to be the same as or larger than the width dimension of the leading end side restricted portion 51 of the terminal 20. An up-down dimension of each of the recesses 62 is formed so as to be the same as or larger than an up-down dimension of the leading end side restricted portion 51.

A front-rear dimension of each of the recesses 62 is formed so as to be the same as or larger than a front-rear dimension of the leading end side restricted portion 51. Accordingly, in a state in which the leading end side restricted portion 51 has been pushed into the recesses 62 toward the front, the leading end side restricted portion 51 does not project out into the housing intermediate portion 60B (the portion formed with the retainer-fitting opening 60BH).

As illustrated in FIG. 3, in a state in which the terminal 20 is accommodated in the corresponding accommodation portion 61, an upper portion of the accommodation portion 61 in the housing front portion 60A configures a leading end placement portion (an upper portion of the accommodation portion 61 in the housing front portion 60A) in which the leading end portion 50 of the terminal 20 is disposed, and a lower portion of the accommodation portion 61 in the housing front portion 60A configures a spring placement portion (a lower portion of the accommodation portion 61 in the housing front portion 60A) in which part of the spring portion 40 is disposed. In this state, the second bent portion 45 of the spring portion 40 is disposed in the accommodation portion 61 in the housing intermediate portion 60B.

A terminal plug-in opening 61F is formed at the front side of the leading end placement portion (the upper portion of the accommodation portion 61 in the housing front portion 60A). The terminal plug-in opening 61F penetrates in the front-rear direction through a front wall of the housing 60 that partitions an external space in front of the housing 60 from the accommodation portion 61, and the terminal plug-in opening 61F has a rectangular cross-section profile as sectioned orthogonally to the housing front-rear direction. A side of the terminal plug-in opening 61F corresponding to a front face 60F of the housing 60 is formed with a tapered portion 61FA that gradually widens in the up-down and left-right directions on progression toward the front side of the housing. The tapered portion 61FA guides a male terminal of the connection target 90 into the terminal plug-in opening 61F. The male terminal of the connection target 90 is plugged into the terminal plug-in opening 61F in order to electrically connect the terminal 20 to the connection target 90.

### Leading End-Forward Restriction Portion

In a state in which the leading end side restricted portion 51 of the terminal 20 has been disposed in the corresponding recesses 62, if the leading end portion 50 of the terminal 20 attempts to move in the connector forward direction, the right plate portion 51R of the leading end side restricted portion 51 abuts the housing 60, and the left plate portion 51L of the leading end side restricted portion 51 abuts the corresponding recess in the housing 60. The recesses 62 in the housing 60 (a leading end-forward restriction portion) thus limit a movement range of the leading end portion 50 toward the connector front.

Similarly, movement ranges of the leading end portion 50 in the connector right direction, the connector left direction, the connector upward direction, and the connector downward direction are limited by parts of the housing 60.

Since the rear sides of the recesses 62 open into the retainer-fitting opening 60BH, a movement range of the leading end portion 50 in the rearward direction is not limited by the housing 60.

### Abutting Portion

As illustrated in FIG. 3, the base end side restricted portion 32 is disposed between the corresponding left and right pair of the side wall faces 61S of the housing intermediate portion 60B in the vicinity of front ends of the side wall faces 61S. A projection 63 serving as an abutting portion that reduces the spacing between the left and right pair of side wall faces 61S of the housing intermediate portion 60B (the width dimension of the accommodation portion 61) is formed in the vicinity of an upper front end portion of each of the left and right pair of side wall faces 61S of the housing intermediate portion 60B. The projections 63 are each formed in a substantially rectangular block shape. The side plate portions 34 of the base end side restricted portion 32 of the corresponding terminal 20 are disposed directly below the corresponding projections 63.

Accordingly, if the base end portion 30 of the terminal 20 attempts to move in the connector upward direction, the upper face 34U of the right side plate portion 34 of the base end side restricted portion 32 abuts a lower face of the projection 63 on the right side, and the upper face 34U of the left side plate portion 34 of the base end side restricted portion 32 abuts a lower face of the projection 63 on the left side. Namely, the projections 63 (abutting portions) configuring part of the housing 60 limit a movement range of the base end portion 30 in the connector upward direction.

A lance anchor hole 64 is formed in the bottom face 61B of each of the accommodation portions 61 at a position where the base end side restricted portion 32 is disposed. Each lance anchor hole 64 is formed penetrating the bottom face 61B, and is configured to anchor the lance 36 of the base end portion 30 of the corresponding terminal 20.

During an assembly operation, when the lance 36 of the base end portion 30 of the terminal 20 reaches the lance anchor hole 64 as the terminal 20 is being pushed into the accommodation portion 61, the lance 36 enters and is anchored by the lance anchor hole 64. When the lance 36 is anchored by the lance anchor hole 64, movement of the base end portion 30 of the terminal 20 in the connector rearward direction is limited.

### Retainer 70

Explanation follows regarding the retainer 70. After the terminal 20 has been pushed into and accommodated in the corresponding accommodation portion 61 of the housing 60, the retainer 70 is fitted into the retainer-fitting opening 60BH in the housing 60. When this is performed, anchor portions 70SA formed to left and right side faces 70S of the retainer 70 are anchored by anchoring portions 60SA of the housing 60 (see FIG. 1 and FIG. 2).

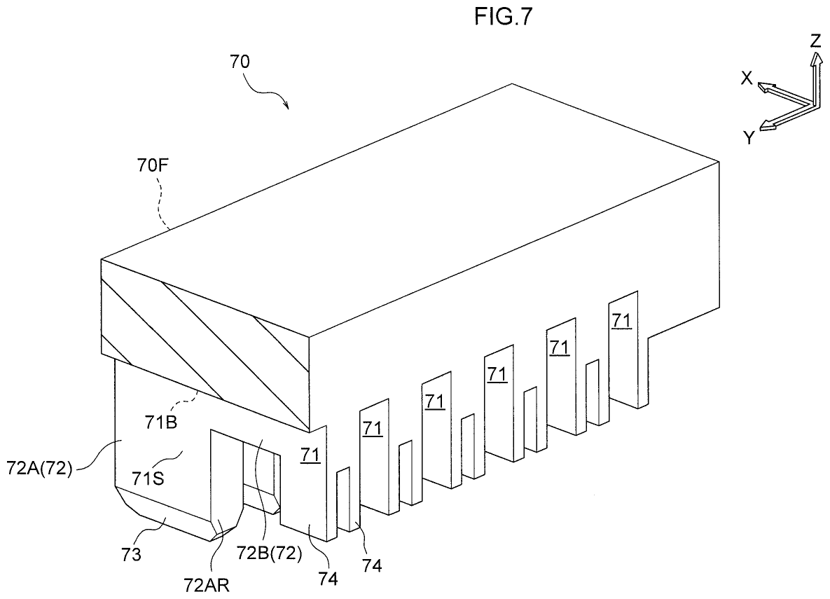

In the following explanation regarding the retainer 70, the arrow X, the arrow Y, and the arrow Z illustrated in FIG. 7 respectively indicate a retainer forward direction, one side (a left side) in a retainer width direction, and a retainer upward direction. Unless specifically stated otherwise, reference to the front and rear, up and down, and width (left and right) is understood to refer to the front and rear in a retainer front-rear direction, up and down in a retainer up-down direction, and width (left and right) in the retainer width direction (left-right direction). In an assembled state, the front, rear, left, right, upward, and downward directions of the retainer 70 are substantially aligned with the front, rear, left, right, upward, and downward directions of the connector 10.

FIG. 7 is a cross-section illustrating the retainer 70 as sectioned at the same position as FIG. 6. Plural (six, so as to correspond to the number of the terminals 20) spring placement grooves 71 with a depth direction oriented in the retainer upward direction are formed in the retainer 70. Each of the spring placement grooves 71 extends along the retainer front-rear direction, and the spring placement grooves 71 are arranged at uniform spacings in the retainer width direction. When the retainer 70 is in a fitted state, a pair of side wall faces 71S of each of the spring placement grooves 71 serves a similar function to the pair of side wall faces 61S of each of the accommodation portions 61 (see FIG. 3). Specifically, as illustrated in FIG. 3, in the fitted state of the retainer 70, the second bent portion 45 and the like of each terminal 20 are disposed between the pair of side wall faces 71S of the corresponding spring placement groove 71.

A width dimension of each of the spring placement grooves 71 is formed so as to be larger than the width dimension of the spring portion 40 of the corresponding terminal 20, and so as to be smaller than the width dimension of the leading end side restricted portion 51 and the width dimension of the base end side restricted portion 32. Moreover, in the fitted state of the retainer 70 a bottom face 71B of each of the spring placement grooves 71 serves a similar function to the top face 61T of the accommodation portions 61 (see FIG. 3). As illustrated in FIG. 3, in the fitted state of the retainer 70, the bottom faces 71B of the respective spring placement grooves 71 are disposed at a position lower than the top face 61T of the housing front portion 60A and lower than a top face of the housing rear portion 60C. Accordingly, in the fitted state of the retainer 70, a state is adopted in which a front face 70F of the retainer 70 is disposed to the rear of the right plate portion 51R, the left plate portion 51L, and the upper plate portion 51T of the corresponding leading end side restricted portion 51.

### Leading End-Rearward Restriction Portion

Accordingly, in the fitted state of the retainer 70, if the leading end portion 50 of the terminal 20 attempts to move in the connector rearward direction, the right plate portion 51R, the left plate portion 51L, and the upper plate portion 51T of the leading end side restricted portion 51 abut the front face 70F of the retainer 70. Namely, the front face 70F of the retainer 70 (a leading end-rearward restriction portion) limits a movement range of the leading end portion 50 in the connector rearward direction.

Accordingly, in the connector 10, the housing 60 and the retainer 70 work in combination to prevent detachment of the leading end portion 50.

The retainer 70 may also be said to include seven downward projections 72 separated by the six spring placement grooves 71.

As illustrated in FIG. 3, a front portion 70A (retainer front portion 70A) of the retainer 70 is disposed at a location where the side wall faces 61S are not formed to the housing intermediate portion 60B. Accordingly, downward projections 72A of the retainer front portion 70A are formed to project further downward. In the fitted state of the retainer 70, lower ends of the downward projections 72 are in a state either contacting or close to the bottom face 61B of the accommodation portion 61 at the retainer front portion 70A. Tapered portions 73 with gradually decreasing width dimensions and up-down dimensions are formed in the vicinity of the lower ends of the downward projections 72A of the retainer front portion 70A.

As illustrated in FIG. 3, in the fitted state of the retainer 70, rear faces 72AR of the downward projections 72A of the retainer front portion 70A are disposed in front of the pair of side plate portions 34 of the base end side restricted portion 32 of the corresponding terminal 20.

### Base End-Forward Restriction Portion

Accordingly, in the fitted state of the retainer 70, if the base end portion 30 of the terminal 20 attempts to move in the connector forward direction, the front faces 34F of the left and right pair of side plate portions 34 of the base end side restricted portion 32 abut the rear faces 72AR of the downward projections 72A of the corresponding retainer front portion 70A. Namely, the rear faces 72AR (base end-forward restriction portions) of the downward projections 72A of the retainer front portion 70A limit a movement range of the base end portion 30 in the connector forward direction.

Moreover, a retainer rear portion 70B is disposed at the location of the housing intermediate portion 60B where the side wall faces 61S are formed. Downward projections 72B of the retainer rear portion 70B are therefore formed so as to project downward by a smaller amount than at the retainer front portion 70A.

### Base End-Rearward Restriction Portion

Moreover, base end-rearward restriction portions 74 are provided projecting further downward from a rear portion of each of the downward projections 72B of the retainer rear portion 70B. In the fitted state of the retainer 70, the base end-rearward restriction portions 74 are disposed at the rear of the projections 63 of the housing 60 and project further downward than the projections 63. The respective base end-rearward restriction portions 74 adopt a state disposed to the rear of the pair of side plate portions 34 of the base end side restricted portion 32 of the corresponding terminal 20.

Accordingly, in the fitted state of the retainer 70, if the base end portion 30 of the terminal 20 attempts to move in the connector rearward direction, the rear faces 34R of the left and right pair of side plate portions 34 of the base end side restricted portion 32 abut the corresponding base end-rearward restriction portions 74. Namely, the base end-rearward restriction portions 74 of the retainer 70 limit a movement range of the base end portion 30 in the connector rearward direction.

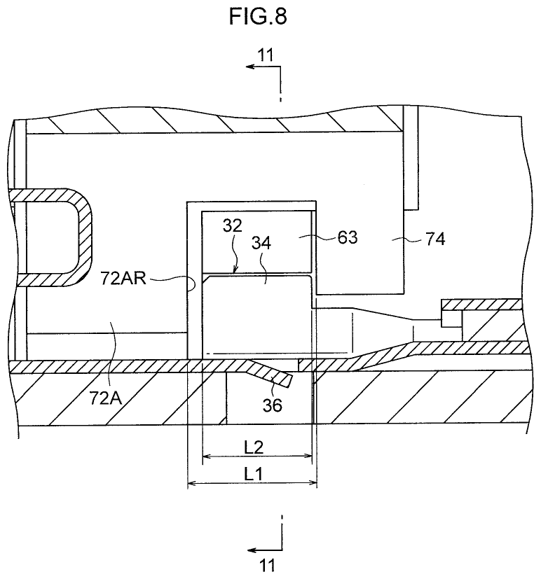

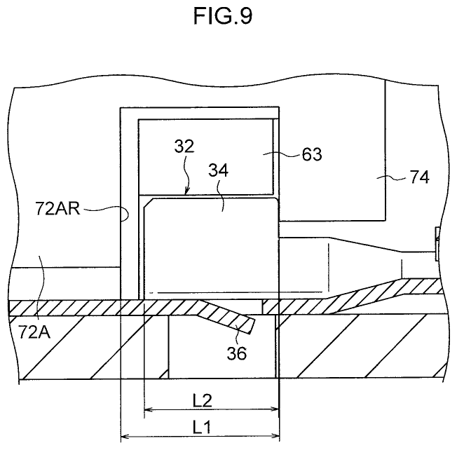

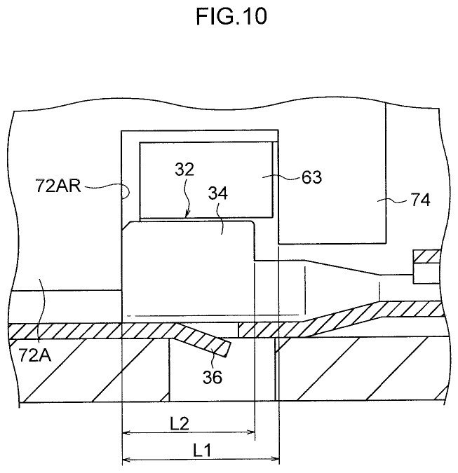

As illustrated in FIG. 8, a front-rear dimension L1 from the rear face 72AR of the downward projection 72A of the retainer front portion 70A to the base end-rearward restriction portion 74 is formed so as to be larger than a front-rear dimension L2 of the base end side restricted portion 32 of the terminal 20. Accordingly, when the retainer 70 is in the fitted state to the housing 60 (namely, in an assembled state), the base end portion 30 is capable of moving with respect to the housing 60 and the retainer 70 within a predetermined movement range (a range corresponding to L1-L2) in the connector front-rear direction. Namely, if the electric cable 80 is tugged, the base end side restricted portion 32 moves in the connector rearward direction as illustrated in FIG. 9. Conversely, if the electric cable 80 is pushed in, the base end side restricted portion 32 moves in the connector forward direction as illustrated in FIG. 10.

### Operation and Advantageous Effects

Next, explanation follows regarding operation and advantageous effects of the connector 10 according to the present exemplary embodiment.

The connector 10 of the present exemplary embodiment includes the terminals 20, the housing 60, and the retainer 70. The retainer 70 is fitted to the housing 60 in which the terminals 20 are accommodated.

Each of the terminals 20 includes the base end portion 30 provided with the electric cable connection portion 31 that connects to the electric cable 80, and the leading end portion 50 provided with the contact portion 52 that contacts the connection target 90. As illustrated in FIG. 3, the housing 60 and the retainer 70 work in combination to prevent detachment of the leading end portion 50.

In the fitted state of the retainer 70 to the housing 60 (namely, an assembled state), the base end portion 30 is capable of moving with respect to the housing 60 and the retainer 70 in the connector front-rear direction that corresponds to an insertion/removal direction of the connection target 90. Each of the terminals 20 also includes the spring portion 40 positioned between the base end portion 30 and the leading end portion 50.

Accordingly, even if the electric cable 80 flexes so as to tug or push in the corresponding terminal 20 in the connector front-rear direction as a result of vibration, shock, or the like, the base end portion 30 provided with the electric cable connection portion 31 moves in the connector front-rear direction with respect to the housing 60 and the retainer 70, enabling the effect of the flexing on the housing 60 and the retainer 70 to be reduced. As a result, the flexing can be suppressed from affecting the leading end portion 50 through the housing 60 and the retainer 70.

Moreover, even if the electric cable 80 flexes so as to tug or push in the corresponding terminal 20 in the connector front-rear direction as a result of vibration, shock, or the like, the spring portion 40 positioned between the leading end portion 50 and the base end portion 30 deforms in response to this flexing, thereby enabling the effect of the flexing on the leading end portion 50 provided with the contact portion 52 to be reduced.

Sliding of the contact point between the contact portion 52 and the connection target 90 is suppressed in the above manner.

Moreover, movement of the base end portion 30 with respect to the housing 60 and the retainer 70 in the connector front-rear direction is limited to a predetermined range, thereby suppressing plastic deformation of the spring portion 40.

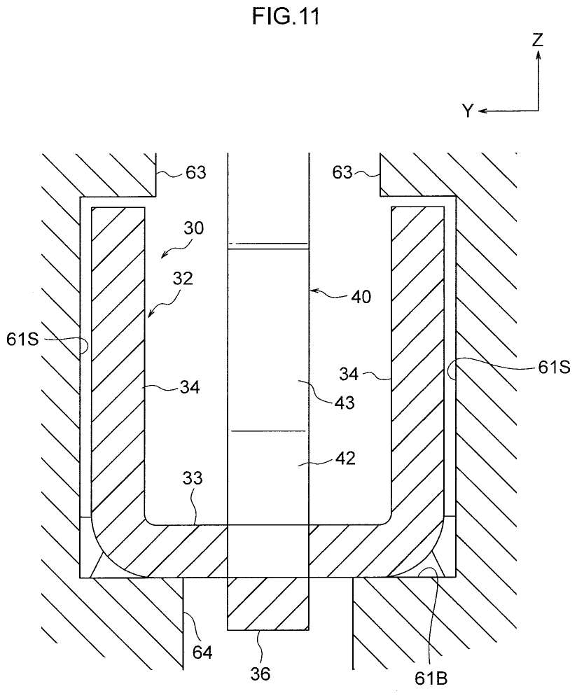

In the present exemplary embodiment, as illustrated in FIG. 11, in the fitted state of the retainer 70 to the housing 60 (namely the assembled state), the base end portion 30 is movable within a predetermined movement range in the connector up-down direction.

Accordingly, even if the electric cable 80 flexes so as to move the terminal 20 in the connector up-down direction, the effect of this flexing on the housing 60 and the retainer 70 can be reduced. As a result, the flexing can be suppressed from affecting the leading end portion 50 through the housing 60 and the retainer 70.

Moreover, even if the electric cable 80 flexes so as to tug or push in the terminal 20 in the connector up-down direction as a result of vibration, shock, or the like, the spring portion 40 positioned between the leading end portion 50 and the base end portion 30 deforms in response to this flexing, thereby enabling the effect of the flexing on the leading end portion 50 provided with the contact portion 52 to be reduced.

Moreover, the movement range of the base end portion 30 in the connector up-down direction is limited to a predetermined range, thereby suppressing plastic deformation of the spring portion 40.

In the present exemplary embodiment, as illustrated in FIG. 11, in the fitted state of the retainer 70 to the housing 60 (namely the assembled state), the base end portion 30 is movable within a predetermined movement range in the connector left-right direction.

Accordingly, even if the electric cable 80 flexes so as to move the terminal 20 in the connector left-right direction, the effect of the flexing on the housing 60 and the retainer 70 can be reduced. As a result, the flexing can be suppressed from affecting the leading end portion 50 through the housing 60 and the retainer 70.

Moreover, even if the electric cable 80 flexes so as to tug or push in the terminal 20 in the connector left-right direction as a result of vibration, shock, or the like, the spring portion 40 positioned between the leading end portion 50 and the base end portion 30 deforms in response to this flexing, thereby enabling the effect of the flexing on the leading end portion 50 provided with the contact portion 52 to be reduced.

Moreover, the movement range of the base end portion 30 in the connector left-right direction is limited to a predetermined range, thereby suppressing plastic deformation of the spring portion 40.

In the present exemplary embodiment, the housing 60 includes the leading end placement portion (the upper portion of the accommodation portion 61 in the housing front portion 60A) where the leading end portion 50 of the terminal 20 can be disposed. This leading end placement portion (the upper portion of the accommodation portion 61 in the housing front portion 60A) includes the leading end-forward restriction portions (the recesses 62 in the housing 60) that limit the movement range of the leading end portion 50 in the connector forward direction. Moreover, the retainer 70 includes the leading end-rearward restriction portion (the front face 70F of the retainer 70) that limits the movement range of the leading end portion 50 in the connector rearward direction in the fitted state of the retainer 70 to the housing 60.

Accordingly, during assembly of the connector 10, the terminal 20 can be provisionally positioned with respect to the housing 60 by pushing in the terminal 20 in the connector forward direction until the leading end portion 50 of the terminal 20 abuts the leading end-forward restriction portions (the recesses 62 in the housing 60) in the leading end placement portion (the upper portion of the accommodation portion 61 in the housing front portion 60A). Detachment of the leading end portion 50 of the terminal 20 can then be prevented by fitting the retainer 70 into the housing 60. This enables the connector 10 to be assembled easily.

In the present exemplary embodiment, the housing 60 includes the bottom portions (bottom faces 61B of the accommodation portions 61) that limit the movement range of the base end portion 30 in the connector downward direction, this being the fitting direction of the retainer 70, and the projections 63, serving as abutting portions, that restrict the movement range of the base end portion 30 in the connector upward direction, this being the opposite direction to the fitting direction of the retainer 70. The base end portion 30 is thus suppressed from moving by a large amount in the connector up-down direction during assembly of the connector 10, even in a state prior to fitting the retainer 70 into the housing 60. This thereby enables the connector 10 to be assembled easily.

In the present exemplary embodiment, the base end portion 30 of the terminal 20 includes the lance 36, and the housing 60 includes the lance anchor hole 64 configured to anchor the lance 36.

Accordingly, during assembly of the connector 10, the lance 36 of the base end portion 30 is anchored by the lance anchor hole 64 in the housing 60 by pushing the terminal 20 in the connector forward direction into the accommodation portion 61 in the housing 60, thereby provisionally limiting the movement range of the base end portion 30 in the connector rearward direction.

The movement range of the base end portion 30 in the connector rearward direction is thus limited in a state prior to fitting the retainer 70, enabling the connector 10 to be assembled easily.

In the present exemplary embodiment, the base end side restricted portion 32 of the terminal 20 is formed with the tapered faces 35. Accordingly, as the terminal 20 is pushed into the accommodation portion 61 of the housing 60 in the connector forward direction, the tapered faces 35 of the base end side restricted portion 32 abut the projections 63 of the housing 60 such that the base end side restricted portion 32 is guided below the projections 63. This enables the base end side restricted portion 32 that includes the lance 36 to be easily disposed at the connector lower side of the projections 63. The terminal 20 can thus be pushed into the accommodation portion 61 in the housing 60 easily.

In the present exemplary embodiment, the retainer 70 includes the base end-forward restriction portion (the rear faces 72AR of the downward projections 72A of the retainer front portion 70A) that limits the movement range of the base end portion 30 in the connector forward direction in the assembled state. When pushing the connector 10 into the accommodation portion 61 in the housing 60, the spring portion 40 and the like of the terminal 20 can be pushed in more easily, without catching on the base end-forward restriction portion, than in a configuration in which the housing 60 includes a portion configured to limit the movement range of the base end portion 30 in the connector forward direction.

As illustrated in FIG. 3, in the present exemplary embodiment, an insertion-removal axis AX1 of the contact portion 52 of the terminal 20 is substantially parallel to an electric cable connection axis AX2 of the electric cable connection portion 31 (a connection axis of a flexible wiring member connection portion), but is at a position offset with respect to the electric cable connection axis AX2 in the connector up-down direction.

Accordingly, the ease of deformation of the spring portion 40 can be secured while suppressing an increase in the front-rear direction dimension of the connector 10, while still effectively suppressing sliding of the contact point.

Moreover, in the present exemplary embodiment, the insertion-removal axis AX1 and the electric cable connection axis AX2 are disposed at positions offset in the connector up-down direction, in addition to which the spring portion 40 extending from the base end portion 30 to the leading end portion 50 is configured including the first bent portion 43 and the second linear portion 44 collectively serving as a doubling-back portion that doubles back toward the connector rearward direction. This enables the ease of deformation of the spring portion 40 to be even better secured, while also enabling sliding of the contact point to be more effectively suppressed.

Moreover, in the present exemplary embodiment, a connector forward direction end portion of the doubling-back portion (the first bent portion 43) is disposed in the accommodation portion 61 in the housing front portion 60A further toward the front than the housing intermediate portion 60B into which the retainer 70 is fitted. This enables the spring portion 40 to be set with a longer overall length, easily securing the ease of deformation of the spring portion 40. In particular, in the present exemplary embodiment, the first bent portion 43 configuring the connector forward direction end portion of the doubling-back portion is located further toward the connector front side than a contact point P (see FIG. 3) of the contact portion 52 of the terminal 20. This is excellent in terms of absorbing movement of the base end portion 30 as a result of deformation of the spring portion 40.

Moreover, as illustrated in FIG. 3, in the present exemplary embodiment a connector rearward direction end portion of the doubling-back portion (the second bent portion 45) of the terminal 20 is disposed between the pair of side wall faces 71S of the corresponding spring placement groove 71. Namely, the connector rearward direction end portion of the doubling-back portion (the second bent portion 45) of the terminal 20 is disposed in the accommodation portion 61 in the housing intermediate portion 60B. This enables the spring portion 40 to be set with an even longer overall length, making the ease of deformation of the spring portion 40 even easier to secure.

### Supplementary Explanation to the Above Exemplary Embodiment

In the exemplary embodiment described above, explanation has been given regarding an example in which detachment of the leading end portion 50 is prevented by the housing 60 and the retainer 70 working in combination. However, the present invention is not limited thereto. For example, configuration may be made in which the leading end portion is prevented from detaching from the housing by press-fitting the leading end portion into the housing. Alternatively, configuration may be made in which insert molding is employed to prevent the leading end portion from detaching from the housing.

In the exemplary embodiment described above, explanation has been given regarding an example in which the projections 63 are formed to the housing 60, and the projections 63 function as the abutting portions that restrict the movement range of the base end portion 30 in a fitting-opposite direction (connector upward direction), this being the opposite direction to the direction in which the retainer 70 is fitted. However, the present invention is not limited thereto. For example, an abutting portion that restricts the movement range of the base end portion 30 in the connector upward direction may be formed to the retainer 70, instead of forming the projections 63 to the housing 60.

Moreover, in the exemplary embodiment described above, explanation has been given regarding an example in which the movement range of the base end portion 30 in the connector forward direction is limited by the rear faces 72AR (the base end-forward restriction portions) of the downward projections 72A of the retainer front portion 70A. However, the present invention is not limited thereto. Configuration may be made in which the movement range of the base end portion 30 in the connector forward direction is limited by part of the housing 60 instead of by the retainer 70.

### Other Exemplary Embodiment

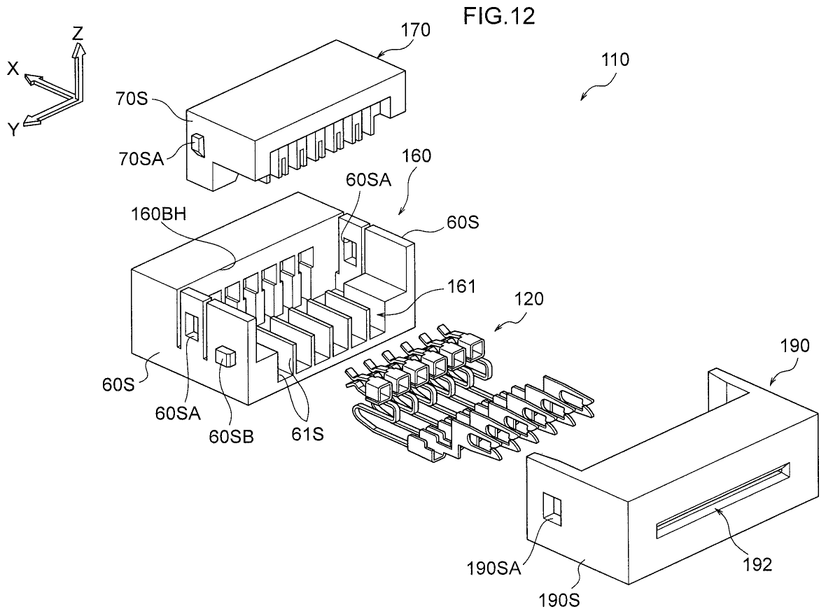

Lastly, explanation follows regarding a connector 110 (FPC connector) according to another exemplary embodiment of the present invention, with reference to FIG. 12 to FIG. 21.

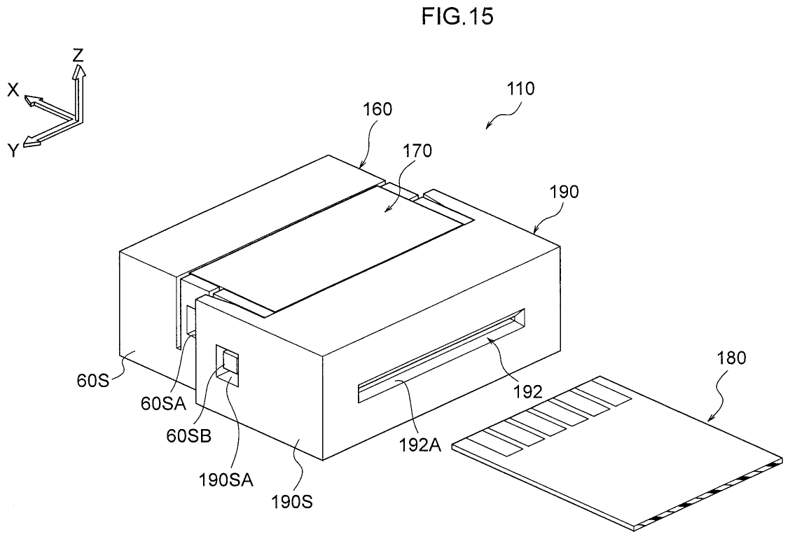

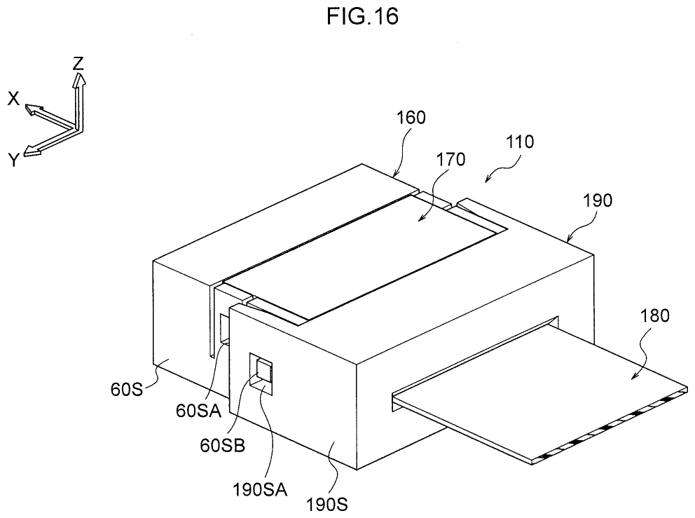

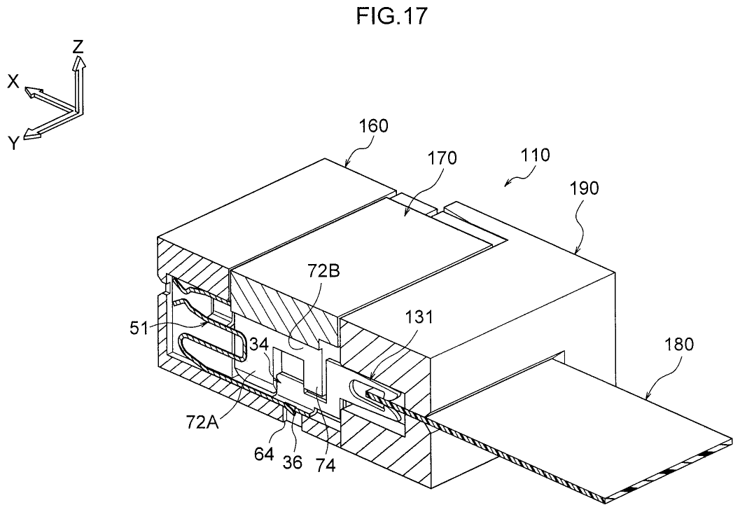

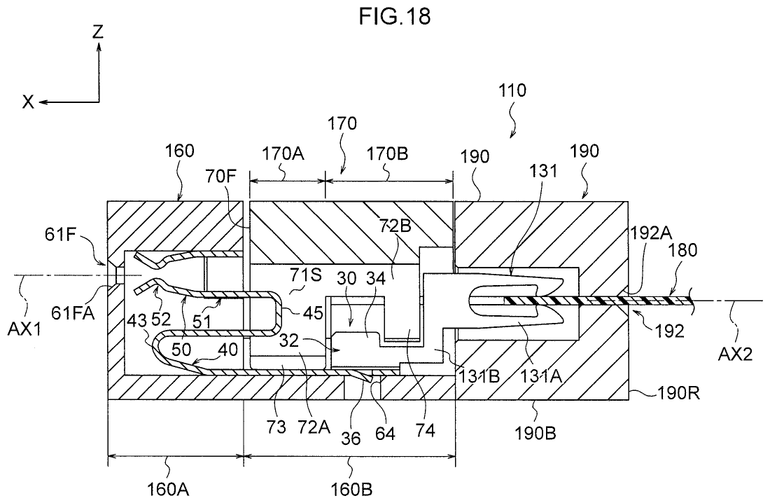

As illustrated in FIG. 17, FIG. 18, etc., the connector 110 of the other exemplary embodiment differs from that of the exemplary embodiment described above in that one end side (a connector rear side) of each terminal 120 is connected to an FPC 180 (flat wiring member) as a flexible wiring member instead of to the electric cable 80. Due to this difference, the base end portion 30 and the like of the terminal 120 differ from those of the connector 10 according to the exemplary embodiment described above. Moreover, in the other exemplary embodiment, unlike the exemplary embodiment described above, the FPC 180 serving as a flexible wiring member and a flat wiring member can be inserted and removed freely with respect to the connector 110 in an assembled state of the connector 110 (see FIG. 15 and FIG. 16).

### Specific Explanation Follows Regarding the Connector 110.

### Connector

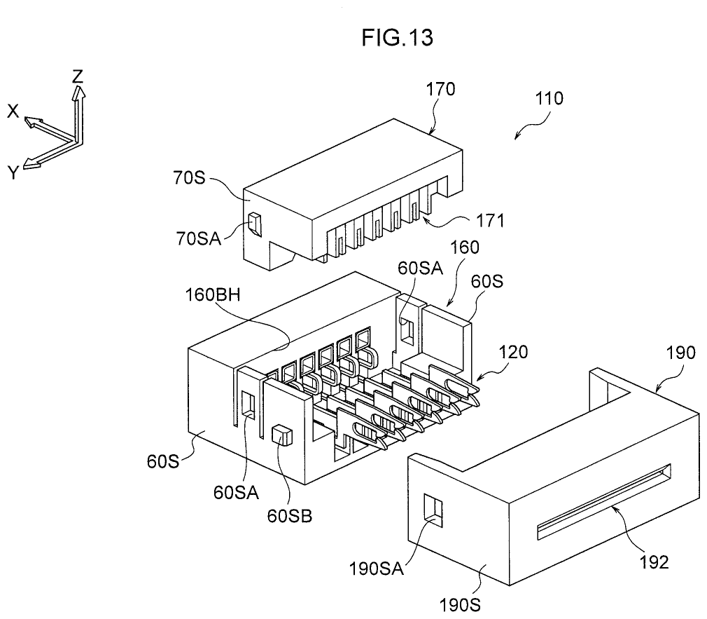

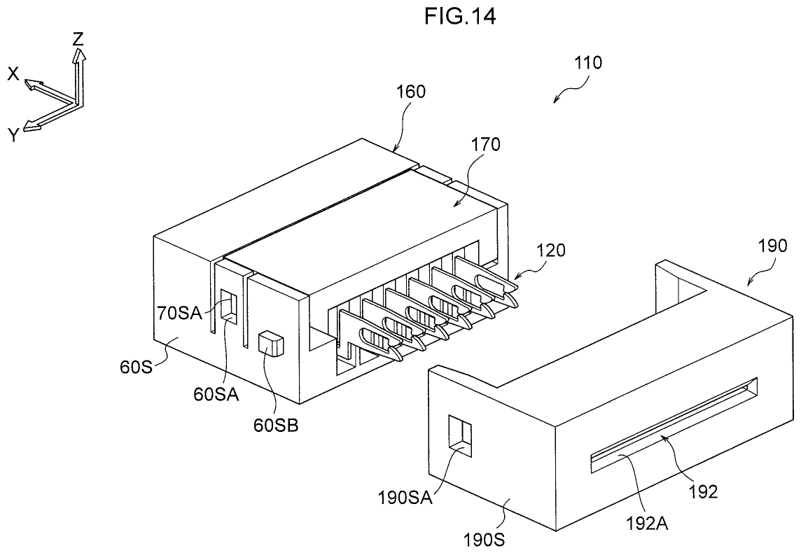

As illustrated in FIG. 12, the connector 110 according to the other exemplary embodiment includes plural (six) of the terminals 120, a housing 160, a retainer 170, and a cover 190. First, the terminals 120 are accommodated in the housing 160 (see FIG. 13), after which the retainer 170 is fitted into the housing 160 in which the terminals 120 are accommodated (see FIG. 14), and the cover 190 is assembled, thereby assembling the connector 110 (see FIG. 15).

### Terminal

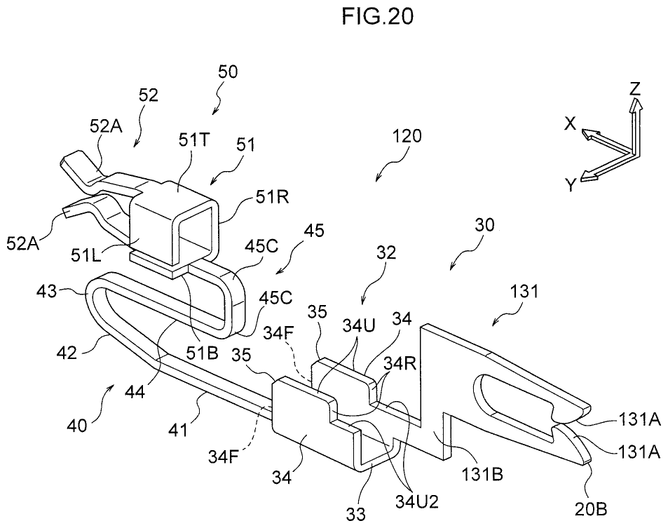

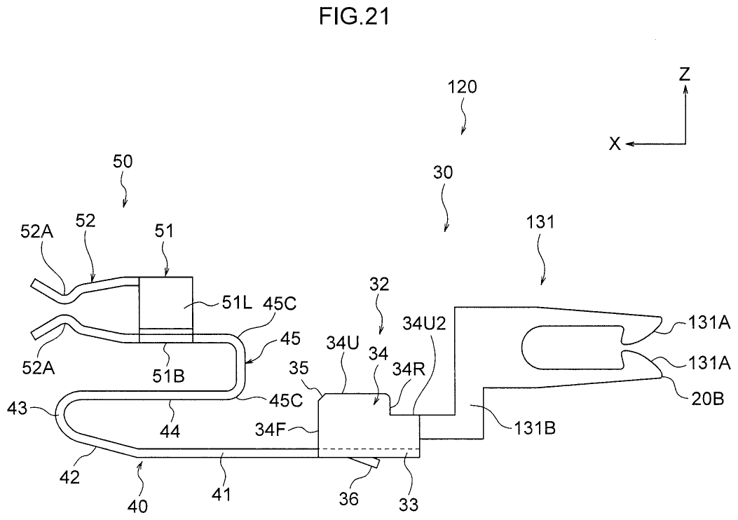

The six terminals 120 have the same configuration as each other. One of the six terminals 120 is illustrated in FIG. 20 and FIG. 21. Explanation follows regarding the terminal 120.

The terminals 120 are, for example, formed by punching and then bending a sheet material. The material employed for the terminals 120 is a material with electrically conductive properties, such as a copper alloy.

Each of the terminals 120 includes a base end portion 30 configuring one end side of the terminal 20, a leading end portion 50 configuring the other end side of the terminal 20, and a spring portion 40 positioned between the leading end portion 50 and the base end portion 30.

### Base End Portion 30

The base end portion 30 extends from a rear end 20B of the terminal 120 toward the front. The base end portion 30 includes an FPC connection portion 131 and a base end side restricted portion 32 in this sequence on progression from the one end side to the other end side.

### FPC Connection Portion 131

As illustrated in FIG. 18 etc., the FPC connection portion 131 is a portion configured to connect to the FPC 180 that serves as a flexible wiring member, and corresponds to a flexible wiring member connection portion of the present invention. The FPC connection portion 131 includes contact portions 131A configured to contact the FPC 180 (see FIG. 18), and a displacement portion 131B configured such that a contact position with the FPC 180 is displaced toward a connector up-down direction intermediate side of the base end side restricted portion 32.

The plate thickness direction of the FPC connection portion 131 is oriented in the connector width direction. The other end side (leading end side) of the FPC connection portion 131 is connected to a right side plate portion 34 of a base end side restricted portion 32 (to one of a pair of side plate portions 34), described later. The FPC connection portion 131 and the right side plate portion 34 are positioned in the same plane as each other.

The contact portions 131A are formed in a pair, and contact the FPC 180 by nipping the FPC 180 from two faces.

### Base End Side Restricted Portion 32

The base end side restricted portion 32 is a portion configured to abut the housing 160 and the retainer 170 in order to limit a movement range of the base end portion 30. The base end side restricted portion 32 is configured with an upward-opening U-shaped cross-section profile as sectioned orthogonally to the terminal front-rear direction. Namely, the base end side restricted portion 32 includes a bottom plate portion 33 extending in the width direction, the right side plate portion 34 extending upward from a right side end portion of the bottom plate portion 33, and a left side plate portion 34 extending upward from a left side end portion to bottom plate portion 33. The left side plate portion 34 and the right side plate portion 34 of the base end side restricted portion 32 are also collectively referred to as the pair of side plate portions 34 of the base end side restricted portion 32.

Each of the side plate portions 34 includes a front-facing front face 34F, an upward-facing upper face 34U, and a rear-facing rear face 34R. Tapered faces 35 facing in an oblique direction running upward and toward the front are formed between the front faces 34F and the upper faces 34U. Each of the side plate portions 34 further includes an upward-facing second upper face 34U2. Each of the second upper faces 34U2 is formed so as to connect to a lower end of the rear face 34R, and is positioned lower than and to the rear of the upper face 34U.

As illustrated in FIG. 18 and FIG. 21, the bottom plate portion 33 of the base end side restricted portion 32 is formed with a lance 36. The lance 36 is formed by bending a width direction central portion of the bottom plate portion 33 downward (toward a plate thickness direction outer face side).

### Spring Portion 40

The spring portion 40 includes a first linear portion 41, an inclined portion 42, a first bent portion 43, a second linear portion 44, and a second bent portion 45 in this sequence on progression from one end side toward the other end side. The structure of the spring portion 40 is the same as that of the spring portion 40 of the terminal 20 of the exemplary embodiment described above, and so explanation thereof is omitted.

### Leading End Portion 50

The leading end portion 50 includes a leading end side restricted portion 51 and a contact portion 52. The leading end side restricted portion 51 is a portion configured to abut the housing 160 and the retainer 170 in order to limit a movement range of the leading end portion 50. The structure of the leading end portion 50 is the same as that of the leading end portion 50 of the terminal 20 of the exemplary embodiment described above, and so explanation thereof is omitted.

### Housing 160

Explanation follows regarding the housing 160. The housing 160 is formed in a substantially rectangular block shape from an insulating body configured by a synthetic resin or the like.

### Accommodation Portion 161

The housing 160 includes accommodation portions 161 configured to accommodate the terminals 120. Plural of the accommodation portions 161 are formed (six in the present exemplary embodiment, so as to correspond to the number of the terminals 120). The six accommodation portions 161 are configured similarly to each other, and are formed at uniform spacings in the housing width direction.

As illustrated in FIG. 12 and FIG. 13, the terminals 120 can be accommodated in the corresponding accommodation portions 161 by pushing the terminals 120 toward the front from the rear of the housing 160.

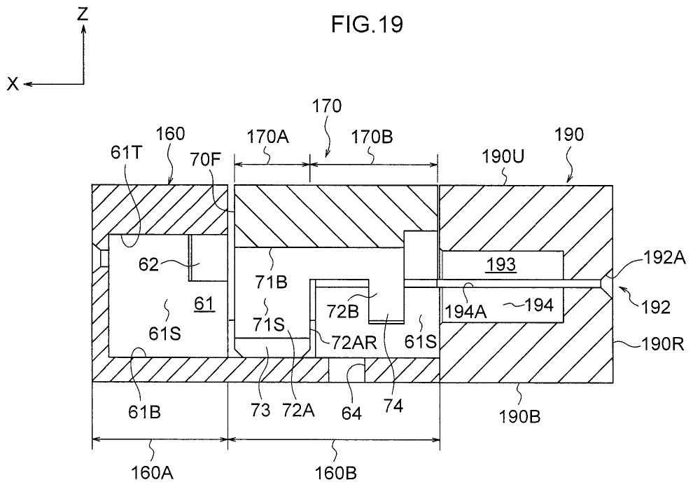

As illustrated in FIG. 12 and FIG. 13, a rear portion 160B of the housing 160 (housing rear portion 160B, see FIG. 19) is formed with a substantially rectangular shaped retainer-fitting opening 160BH that opens upward from the housing. The retainer-fitting opening 160BH is joined to the six accommodation portions 161. A top face 61T (see FIG. 19) of the accommodation portions 161 is therefore not present at the housing rear portion 160B.

In the housing rear portion 160B, left and right pairs of side wall faces 61S are formed lower than left and right side walls 60S of the housing 160.

Moreover, the side wall faces 61S of the housing rear portion 160B are interrupted at a front-rear direction intermediate position of the housing rear portion 160B. Namely, if the housing rear portion 160B is further divided into a front side and a rear side, the side wall faces 61S are formed at the rear side of the housing rear portion 160B, but the side wall faces 61S are not formed at the front side of the housing rear portion 160B.

As illustrated in FIG. 18, the base end side restricted portion 32 of the terminal 120 is disposed between the left and right pair of side wall faces 61S of the housing rear portion 160B (in the accommodation portions 161 of the housing rear portion 160B). The displacement portion 131B of the FPC connection portion 131 of each terminal 120 is disposed in the corresponding accommodation portion 161 in the housing rear portion 160B.

The plural housing portions 161 are separated from each other in a front portion 160A (housing front portion 160A) of the housing 160. Namely, as illustrated in FIG. 19, in the housing front portion 160A a left and right pair of the side wall faces 61S are formed spanning from the bottom face 61B to the top face 61T for each of the accommodation portions 161.

As illustrated in FIG. 18 and FIG. 19, part of the spring portion 40 (for example the first bent portion 43) and the leading end portion 50 of the corresponding terminal 120 are disposed between the left and right pair of side wall faces 61S in the housing front portion 160A (in the accommodation portion 161 in the housing front portion 60A).

In the housing front portion 160A, the spacing between each left and right pair of the side wall faces 61S is formed smaller than a width dimension of the leading end side restricted portion 51.

However, as illustrated in FIG. 19, at a portion of the housing front portion 160A in the vicinity of the top face 61T and adjoining the housing rear portion 160B, recesses 62 are formed to increase the spacing between each left and right pair of the side wall faces 61S. A left and right pair of the recesses 62 is formed to each of the accommodation portions 161 such that the recesses 62 are formed to both of the left and right pair of side wall faces 61S.

The spacing between each left and right pair of the recesses 62 is formed so as to be the same as or larger than the width dimension of the leading end side restricted portion 51 of the terminal 120. An up-down dimension of each of the recesses 62 is formed so as to be the same as or larger than an up-down dimension of the leading end side restricted portion 51.

A front-rear dimension of each of the recesses 62 is formed so as to be the same as or larger than a front-rear dimension of the leading end side restricted portion 51. Accordingly, in a state in which the leading end side restricted portion 51 has been pushed toward the front into the recesses 62, the leading end side restricted portion 51 does not project out into the housing rear portion 160B (the portion formed with the retainer-fitting opening 160BH).

As illustrated in FIG. 18, in a state in which the terminal 120 has been accommodated in the accommodation portion 161, an upper portion of the accommodation portion 161 in the housing front portion 160A configures a leading end placement portion (an upper portion of the accommodation portion 161 in the housing front portion 160A) in which the leading end portion 50 of the terminal 120 is disposed, and a lower portion of the accommodation portion 161 in the housing front portion 160A configures a spring placement portion (a lower portion of the accommodation portion 161 in the housing front portion 160A) in which part of the spring portion 40 is disposed. In this state, the second bent portion 45 of the spring portion 40 is disposed in the accommodation portion 161 of the housing rear portion 160B.

A terminal plug-in opening 61F is formed at the front side of the leading end placement portion (the upper portion of the accommodation portion 161 in the housing front portion 160A). The terminal plug-in opening 61F penetrates in the front-rear direction through a front wall of the housing 160 that partitions an external space in front of the housing 160 from the accommodation portion 161, and the terminal plug-in opening 61F has a rectangular cross-section profile as sectioned orthogonally to the housing front-rear direction. A side of the terminal plug-in opening 61F corresponding to a front face 60F of the housing 160 is formed with a tapered portion 61FA that gradually widens in the up-down and left-right directions on progression toward the front side of the housing.

### Leading End-Forward Restriction Portion

In a state in which the leading end side restricted portion 51 of the terminal 120 has been disposed in the corresponding recesses 62, if the leading end portion 50 of the terminal 120 attempts to move in the connector forward direction, the right plate portion 51R of the leading end side restricted portion 51 abuts the corresponding recess 62 in the housing 160, and the left plate portion 51L of the leading end side restricted portion 51 abuts the corresponding recess 62 in the housing 160. The recesses 62 in the housing 160 (a leading end-forward restriction portion) thus limit a movement range of the leading end portion 50 toward the connector front.

Similarly, movement ranges of the leading end portion 50 in the connector right direction, the connector left direction, the connector upward direction, and the connector downward direction are limited by parts of the housing 160.

Since the rear sides of the recesses 62 open into the retainer-fitting opening 160BH, a movement range of the leading end portion 50 in the rearward direction is not limited by the housing 160.

As illustrated in FIG. 18, the base end side restricted portion 32 is disposed in the vicinity of a front end of the housing rear portion 160B between the left and right pair of side wall faces 61S. Note that the projections 63 (see FIG. 6) serving as abutting portions are not formed to the left and right pair of the side wall faces 61S of the housing rear portion 160B.

Accordingly, in a state prior to fitting the retainer 170 (the state illustrated in FIG. 13), the movement range of the base end portion 30 in the connector upward direction is not limited.

A lance anchor hole 64 is formed in the bottom face 61B of each of the accommodation portions 161 at a position where the base end side restricted portion 32 is disposed. Each lance anchor hole 64 is formed penetrating the bottom face 61B, and is configured to anchor the lance 36 of the base end portion 30 of the corresponding terminal 120.

### Retainer 170

Explanation follows regarding the retainer 170. After the terminal 120 has been pushed into and accommodated in the corresponding accommodation portion 161 of the housing 160, the retainer 170 is fitted into the retainer-fitting opening 160BH in the housing 160. When this is performed, anchor portions 70SA formed to left and right side faces 70S of the retainer 170 are anchored by anchoring portions 60SA of the housing 160 (see FIG. 13 and FIG. 14).

As illustrated in FIG. 13, plural (six in the present exemplary embodiment, so as to correspond to the number of the terminals 120) spring placement grooves 171 with a depth direction oriented in the retainer upward direction are formed in the retainer 170. Each of the spring placement grooves 171 extends along the retainer front-rear direction, and the spring placement grooves 171 are arranged at uniform spacings in the retainer width direction. When the retainer 170 is in a fitted state, a pair of side wall faces 71S of each of the spring placement grooves 171 serves a similar function to the pair of side wall faces 61S of each of the accommodation portions 161 (see FIG. 19). Specifically, as illustrated in FIG. 18, in the fitted state of the retainer 170, the second bent portion 45 and the like of each terminal 120 are disposed between the pair of side wall faces 71S of the corresponding spring placement groove 171.

A width dimension of each of the spring placement grooves 171 is formed so as to be larger than the width dimension of the spring portion 40 of the corresponding terminal 120, and so as to be smaller than a width dimension of the leading end side restricted portion 51 and a width dimension of the base end side restricted portion 32. Moreover, in the fitted state of the retainer 170, a bottom face 71B of each of the spring placement grooves 171 serves a similar function to the top face 61T of the accommodation portion 161 (see FIG. 19). As illustrated in FIG. 19, in the fitted state of the retainer 170, the bottom faces 71B of the respective spring placement grooves 171 are disposed at a position lower than the top face 61T of the housing front portion 160A. Accordingly, in the fitted state of the retainer 170, a state is adopted in which a front face 70F of the retainer 170 is disposed to the rear of the right plate portion 51R, the left plate portion 51L, and the upper plate portion 51T of the corresponding leading end side restricted portion 51.

### Leading End-Rearward Restriction Portion

Accordingly, in the fitted state of the retainer 170, if the leading end portion 50 of the terminal 120 attempts to move in the connector rearward direction, the right plate portion 51R, the left plate portion 51L, and the upper plate portion 51T of the leading end side restricted portion 51 abut the front face 70F of the retainer 170. Namely, the front face 70F of the retainer 170 (a leading end-rearward restriction portion) limits a movement range of the leading end portion 50 toward the connector rear.

Accordingly, in the connector 110, the housing 160 and the retainer 170 work in combination to prevent detachment of the leading end portion 50.

The retainer 170 may also be said to include seven downward projections 172 separated by the six spring placement grooves 171.

As illustrated in FIG. 19, a front portion 170A (retainer front portion 170A) of the retainer 170 is disposed at a location where the side wall faces 61S are not formed to the housing rear portion 160B. Accordingly, downward projections 72A of the retainer front portion 170A are formed to project further downward. In the fitted state of the retainer 170, lower ends of the downward projections 72 are in a state either contacting or close to the bottom face 61B of the accommodation portion 161 at the retainer front portion 170A. Tapered portions 73 with gradually decreasing width dimensions and up-down dimensions are formed in the vicinity of the lower ends of the downward projections 72A of the front portion 170A.

As illustrated in FIG. 18, in the fitted state of the retainer 170, rear faces 72AR of the downward projections 72A of the retainer front portion 170A are disposed in front of the pair of side plate portions 34 of the base end side restricted portion 32 of the corresponding terminal 120.

### Base End-Forward Restriction Portion

Accordingly, in the fitted state of the retainer 170, if the base end portion 30 of the terminal 120 attempts to move in the connector forward direction, the front faces 34F of the left and right pair of side plate portions 34 of the base end side restricted portion 32 abut the rear faces 72AR of the downward projections 72A of the corresponding retainer front portion 170A. Namely, the rear faces 72AR (base end-forward restriction portions) of the downward projections 72A of the retainer front portion 170A limit a movement range of the base end portion 30 in the connector forward direction.

Moreover, a retainer rear portion 170B is disposed at a location of the housing rear portion 160B where the side wall faces 61S are formed. Downward projections 72B of the retainer rear portion 170B are therefore formed so as to project downward by a smaller amount than those at the retainer front portion 170A.

### Base End-Rearward Restriction Portion

Moreover, base end-rearward restriction portions 74 are provided projecting further downward from a rear portion of each of the downward projections 72B of the retainer rear portion 170B. The base end-rearward restriction portions 74 are disposed at the rear of the pair of side plate portions 34 of the base end side restricted portion 32 of the terminal 120.

Accordingly, in the fitted state of the retainer 170, if the base end portion 30 of the terminal 120 attempts to move in the connector rearward direction, the rear faces 34R of the left and right pair of side plate portions 34 of the base end side restricted portion 32 abut the base end-rearward restriction portions 74. Namely, the base end-rearward restriction portion 74 of the retainer 170 limit a movement range of the base end portion 30 in the connector rearward direction.

The base end-rearward restriction portions 74 are disposed above the second upper faces 34U2 of the pair of side plate portions 34 of the base end side restricted portion 32 of the terminal 120.

Accordingly, in the fitted state of the retainer 170, if the base end portion 30 of the terminal 120 attempts to move in the connector upward direction, the second upper faces 34U2 of the left and right pair of side plate portions 34 of the base end side restricted portion 32 abut the base end-rearward restriction portion 74 from below. Namely, the base end-rearward restriction portion 74 of the retainer 170 limits the movement range of the base end portion 30 in the connector upward direction.

Namely, in the present exemplary embodiment, the base end-rearward restriction portion 74 of the retainer 170 functions as an abutting portion that restricts the movement range of the base end portion 30 in the fitting-opposite direction of the retainer 170. Namely, in the present exemplary embodiment the abutting portion is provided to the retainer 170 instead of the housing 160. Of course, the housing 160 may be formed with projections 63 (see FIG. 3, etc.) as abutting portions in the present exemplary embodiment.

As illustrated in FIG. 18, in the fitted state of the retainer 170 to the housing 160, the base end portion 30 is capable of moving with respect to the housing 160 and the retainer 170 in a predetermined movement range in the connector front-rear direction.

### Cover 190

Explanation follows regarding the cover 190. As illustrated in FIG. 14 and FIG. 15, the cover 190 is attached to the housing 160 from the rear side. When this is performed, anchor portions 190SA formed to left and right side walls 190S of the cover 190 are anchored by protrusion shaped anchoring portions 60SB formed to the left and right side walls 60S of the housing 160.

As illustrated in FIG. 15 and FIG. 18, in the assembled state of the connector 110, an upper face 190U, a lower face 190B, the left and right side faces 190S, and a rear face 190R of the cover 190 configure outer surfaces of a rear portion of the connector 110. In the assembled state, the upper face 190U and the lower face 190B of the cover 190 adopt states lying in substantially the same planes as upper faces and lower faces of the housing 160 and the retainer 170. Conversely, the left and right side faces 190S of the cover 190 adopt states in which steps are formed between the left and right side faces 190S and the left and right side walls 60S of the housing 160.

The cover 190 includes a flat wiring member insertion hole 192 for insertion of the FPC 180. An entry side of the flat wiring member insertion hole 192 is formed with a taper 192A to guide the FPC 180 in the up-down and left-right directions.

As illustrated in FIG. 19, the cover 190 includes a terminal accommodation portion 193 to accommodate the FPC connection portions 131 of the plural terminals 120. The terminal accommodation portion 193 is open toward the front.

The cover 190 includes plural (five) partitioning walls 194 to partition the FPC connection portion 131 of the plural (six) terminals 120 from each other. Each of the partitioning walls 194 is formed with a flat wiring member placement groove 194A in which the FPC 180 is disposed.

### Operation and Advantageous Effects

Explanation follows regarding operation and advantageous effects of the present exemplary embodiment.

The connector 110 of the present exemplary embodiment includes the terminals 120, the housing 160, and the retainer 170. The retainer 170 is fitted to the housing 160 in which the terminals 120 are accommodated.

Each of the terminals 120 includes the base end portion 30 provided with the FPC connection portion 131 that connects to the FPC 180, and the leading end portion 50 provided with the contact portion 52 that contacts the connection target 90. As illustrated in FIG. 18, the housing 160 and the retainer 170 work in combination to prevent detachment of the leading end portion 50.

In the fitted state of the retainer 170 to the housing 160 (namely, the assembled state), the base end portion 30 is capable of moving with respect to the housing 160 and the retainer 170 in the connector front-rear direction that corresponds to an insertion/removal direction of the connection target 90. Each of the terminals 120 also includes the spring portion 40 positioned between the base end portion 30 and the leading end portion 50.

Accordingly, even if the FPC 180 flexes so as to tug or push in the corresponding terminal 120 in the connector front-rear direction as a result of vibration, shock, or the like, the base end portion 30 provided with the FPC connection portion 131 moves in the connector front-rear direction with respect to the housing 160 and the retainer 170, enabling the effect of the flexing on the housing 160 and the retainer 170 to be reduced. As a result, the flexing can be suppressed from affecting the leading end portion 50 through the housing 160 and the retainer 170.

Moreover, even if the FPC 180 flexes so as to tug or push in the corresponding terminal 120 in the connector front-rear direction as a result of vibration, shock, or the like, the spring portion 40 positioned between the leading end portion 50 and the base end portion 30 deforms in response to this flexing, thereby enabling the effect of the flexing on the leading end portion 50 provided with the contact portion 52 to be reduced.

Sliding of the contact point between the contact portion 52 and the connection target 90 is suppressed as described above.

Moreover, movement of the base end portion 30 with respect to the housing 160 and the retainer 170 in the connector front-rear direction is limited to a predetermined range, thereby suppressing plastic deformation of the spring portion 40.

Explanation regarding other operation and advantageous effects stemming from configurations similar to those of the exemplary embodiment described above is omitted. Note that the FPC 180 described above may be substituted for an FFC in the other exemplary embodiment.

### EXPLANATION OF THE REFERENCE NUMERALS

10 connector

20 terminal

30 base end portion

31 electric cable connection portion (flexible wiring member connection portion)

40 spring portion

43 first bent portion (doubling-back portion)

44 second linear portion (doubling-back portion)

50 leading end portion

52 contact portion

60 housing

60BH retainer-fitting opening

61 accommodation portion

61B bottom face of accommodation portion (bottom portion)

62 recess (leading end-forward restriction portion)

63 projection (abutting portion)

70 retainer

70F front face (leading end-rearward restriction portion)

72AR rear face of downward projection of retainer front portion (base end-forward restriction portion)

74 base end-rearward restriction portion

80 electric cable (flexible wiring member)

90 connection target

AX1 insertion-removal axis

AX2 electric cable connection axis (connection axis of flexible wiring member connection portion)

110 connector

120 terminal

131 FPC connection portion (flexible wiring member connection portion)

160 housing

170 retainer

180 FPC (flexible wiring member)

190 cover

The disclosure of Japanese Patent Application No. 2017-092783, filed on May 9, 2017, is incorporated in its entirety by reference herein.

1. A connector, comprising:
a terminal configured to electrically connect to an insertable and removable connection target;
a housing configured to accommodate the terminal; and
a retainer configured to fit into the housing in which the terminal is accommodated,
the terminal including:
a base end portion provided with a flexible wiring member connection portion configured to connect to a flexible wiring member,
a leading end portion provided with a contact portion configured to contact the connection target, and
a spring portion positioned between the base end portion and the leading end portion,
the leading end portion being prevented from detaching either by the housing, or by the housing and the retainer working in combination, and
when the retainer is in a state fitted to the housing, the base end portion being movable with respect to the housing within a predetermined movable region in a connector front-rear direction that is an insertion/removal direction of the connection target.

2. The connector of claim 1, wherein:
the housing includes a leading end placement portion at which the leading end portion can be disposed;
the leading end placement portion includes a leading end-forward restriction portion configured to limit a movement range of the leading end portion in a connector forward direction that is a removal direction of the connection target; and
the retainer includes a leading end-rearward restriction portion configured to, when the retainer is in a state fitted to the housing, limit a movement range of the leading end portion in a connector rearward direction that is an insertion direction of the connection target.

3. The connector of claim 1, wherein the housing includes:
a bottom portion configured to restrict movement of the base end portion in a fitting direction of the retainer; and
an abutting portion configured to restrict a movement range of the base end portion in a fitting-opposite direction that is the opposite direction from the fitting direction of the retainer.

4. The connector of claim 3, wherein:
a movement clearance permitting movement of the base end portion in a connector up-down direction that is a fitting direction/fitting-opposite direction of the retainer is present between the base end portion and the bottom portion and between the base end portion and the abutting portion; and
the base end portion is movable within a predetermined movement range in the connector up-down direction when the retainer is in a fitted state to the housing.

5. The connector of claim 1, wherein:
the base end portion is accommodated in a state in which a gap between the base end portion and the housing is present in a connector width direction that is a direction perpendicular both to an insertion direction of the connection target and to a fitting direction of the retainer; and
the base end portion is movable in the connector width direction over a range of the gap when the retainer is in a fitted state to the housing.

6. The connector of claim 1, wherein an insertion-removal axis of the contact portion is substantially parallel to a connection axis of the flexible wiring member connection portion, and is at a position that is offset with respect to the connection axis of the flexible wiring member connection portion in a fitting direction of the retainer.

7. The connector of claim 6, wherein the spring portion includes a doubling-back portion that doubles back in a connector rearward direction that is an insertion direction of the connection target.
